(19) United States
(12) Patent Application Publication
(10) Pub. No.: US 2016/0092506 A1
(43) Pub. Date: Mar. 31, 2016

(54) GENERATING SUGGESTED STRUCTURED QUERIES

(71) Applicant: LinkedIn Corporation, Mountain View, CA (US)

(72) Inventors: Zhifang Liu, Sunnyvale, CA (US); Steven Foote, Santa Clara, CA (US); Daniel Tunkelang, Mountain View, CA (US); Ashley Woodman Hall, Menlo Park, CA (US); Asif Mansoor Ali Makhani, Fremont, CA (US)

(21) Appl. No.: 14/500,693

(22) Filed: Sep. 29, 2014

(51) Int. Cl. G06F 17/30

(52) U.S. Cl. CPC G06F 17/30442; G06F 17/30392

(57) ABSTRACT

Method and system to assist a user in formulating a search query is described. The system may be configured to examine an input string submitted by a user via a search box and present suggestions in the form of structured queries, determine an entity and an entity type that corresponds to the input string and generate search suggestions in the form of complex structured queries. The generated query may be presented on a display device of a user.

### TECHNICAL FIELD

This application relates to the technical fields of software and/or hardware technology and, in one example embodiment, to system and method to generate structured queries.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member. A member profile in an on-line social network system may also represent a group, a company, a school, etc. Member profiles in an on-line social network system may be referred to as simply profiles.

An on-line social network system may include a search system that permits members to search information, such as, e.g., jobs postings, people, etc., within an on-line social network. The searches within the on-line social network may be viewed as navigational (where the intent of the search—search intent—is to locate a specific item, e.g., a particular person) or exploratory (where the intent of the search is to scan through the available information in order to identify potentially interesting or useful items). A navigational search may be fairly specific (e.g., indicating the first and last name of a person). An exploratory search, on the other hand, may return a great number of search results, which may sometimes make it difficult to identify those search results that are most useful. A search system may process a search request by matching a search string against the stored content to determine, which documents or records contain the search string. The documents that contain the search string, or references to those documents, are returned as search results. A search system may obtain a search string, e.g., by accessing input provided by a user via a search box presented as part of Graphical User Interface (GUI).

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to generate structured queries may be implemented;

FIG. 2 is block diagram of a system to generate structured queries, in accordance with one example embodiment;

FIG. 3 is a flow chart of a method to generate structured queries, in accordance with an example embodiment; and

FIG. 4 is an example User Interface screen illustrating presentation of suggestions in the form of structured queries, in accordance with an example embodiment;

FIG. 5 is an example User Interface screen illustrating presentation of the search results together with an automatically generated string included in the search box, the automatically generated string representing a complex structured query, in accordance with an example embodiment; and

FIG. 6 is a diagrammatic representation of an example machine in the form of a computer system within which a set of instructions, for causing the machine to perform any one or more of the methodologies discussed herein, may be executed.

### DETAILED DESCRIPTION

A method and system to generate structured queries in an on-line social network is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, provide recommendations and endorsements for each other and otherwise be in touch via the social network.

The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills, such as, e.g., “product management,” “patent prosecution,” “image processing,” etc.).

The profile of a member may also include information about the member's current and past employment, such as company identifications, professional titles held by the associated member at the respective companies, as well as the member's dates of employment at those companies. A professional title that may be present in a member profile and indicate a professional position of the member during a particular period of employment may be referred to as a title string. Thus, a title string that appears in a member profile may be associated with a particular company and also with a period of time during which the member held, at that company, a particular position.

As mentioned above, an on-line social network system may include a search system that permits members to search for a wide range of information. In one embodiment, a search system may be configured to generate structured queries using one or more techniques described below. Method and system are described for assisting users in the process of formulating search criteria and generating so-called structured queries (also referred to as compound graph queries). A query that is processed by matching one or more keywords against the entire content of a document or a record may be referred to as an unstructured query. A structured query, on the other hand, is a query that is processed by examining some but not all fields in a document to determine whether the content stored in those one or more selected fields contains a search string included in the query. A structured query that is processed by examining some but not all fields in a document may be referred to as a fielded query. A fielded query includes a string that is identified by the search system as an entity of a particular entity type. The search system is then able to determine whether that particular entity type is associated with one or more specific fields in the collection of documents and, if so, search only those specific fields in the documents from the collection. Strings that have been tagged with or identified as being of a particular entity type are entities of that particular entity type. For example, a string “Michael Smith” may be identified by the search system as an entity of type “people.” A string “LinkedIn” may be identified by the search system as an entity of type “companies.”

Another example of a structured query is a so-called faceted query, where, rather than matching text, a search system matches identifiers (ID's). For example, an entity of type “companies” may be a string “LinkedIn,” which also has an ID. In the member profiles, the company that corresponds to the “LinkedIn” string has the same ID. When a user requests a search for “LinkedIn,” the search system determines the ID assigned to the “LinkedIn” string and matches the ID assigned to the “LinkedIn” string with IDs stored in the member profiles. For example, if the entity “LinkedIn” is assigned company ID 1337 in the on-line social network system, a query including the entity “LinkedIn” would result in the search system returning member profiles that are assigned 1337 as an ID in the Current Company facet associated with the profiles.

In one embodiment, a search system may obtain a search string, e.g., by accessing input provided by a user via a search box presented as part of Graphical User Interface (GUI). In one embodiment, a search system may be configured to examine an input string submitted by a user via a search box and present suggestions in the form of structured queries. In operation, as a user starts typing an input string into the search box, the search system determines an auto-completed version of the input string. The search system determines an entity and an entity type that corresponds to the auto-completed version of the input string and generates search suggestions in the form of complex structured queries. A complex structured query includes at least two query items, e.g., an entity and a relationship operator, two entities, etc. The search suggestions may include the determined entity, a relationship operator suitable for expressing a relationship with an entity of that entity type, and an identification of a further entity type that can be related to the determined entity in a manner expressed by the relationship operator. The operation of determining of an auto-completed version of an input string may be referred to as an implied auto complete.

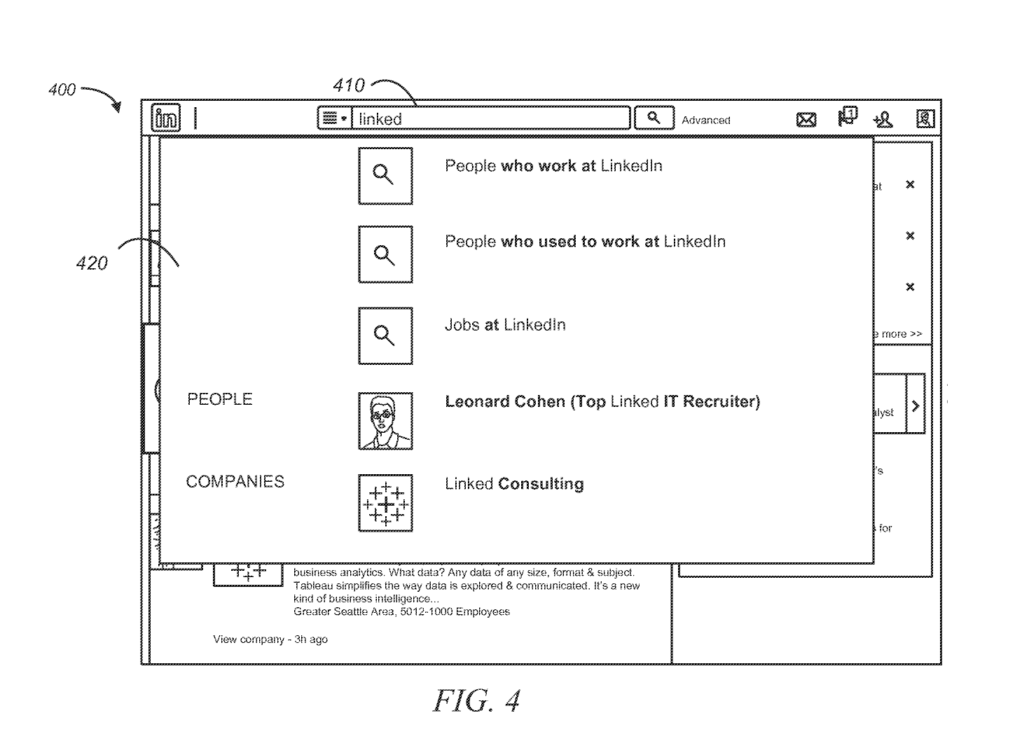

For example, as shown on screen 400 of FIG. 4, an input string entered by a user into the search box 410 is “linked.” The search system performs an implied auto-complete to determine an entity “LinkedIn,” which is of entity type “company.” The search system then determines that, for an entity of type “company,” suitable relationship operators include operators “who work at,” “who used to work at,” and “at.” The search system then generates suggested structured queries “People who work at LinkedIn,” “People who used to work at LinkedIn,” and “Jobs at LinkedIn.” These suggestions are presented on the user's display device in area 420. As shown in FIG. 4, the search system may also retrieve additional suggestions—here entities that include the string “linked.”

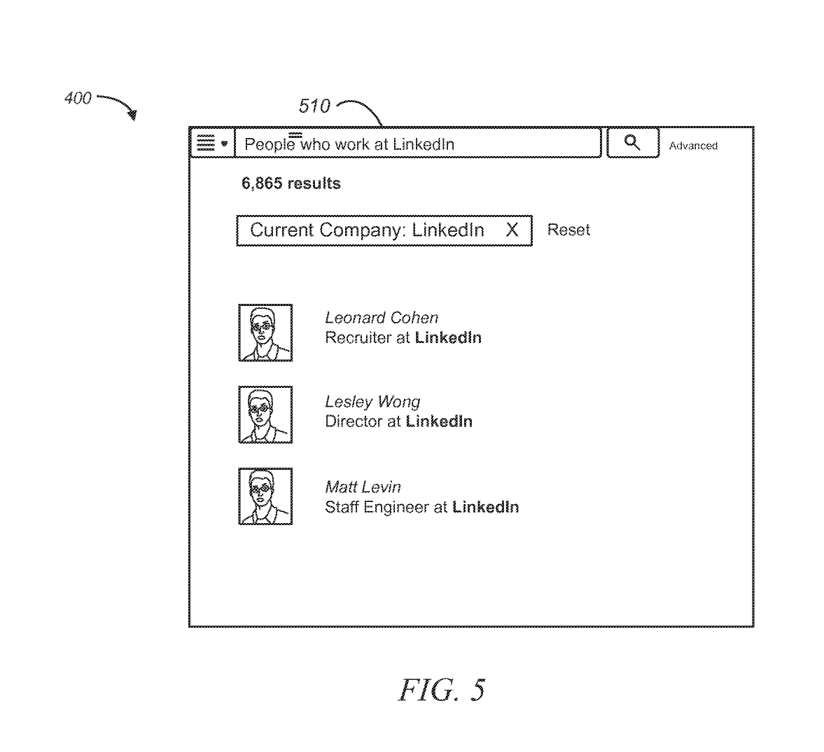

In one embodiment, if a user selects one of the suggested queries, e.g., “People who work at LinkedIn,” the search system processes the selected query and generates search results that can be presented on the display device of the user, as shown on screen 500 of FIG. 5. The search system recognizes that, in the query that corresponds to the string “People who work at LinkedIn,” the string “People” corresponds to an entity type “people,” the string “LinkedIn” corresponds to an entity of type “company, and that the string “who works at” corresponds to a relationship operator. The search system, in one embodiment, is configured to process this query by examining only those profiles in the on-line social network system that represent people (and not companies, or schools, etc.) and, in the profiles that represent people, only examine the profile section that is designated by the on-line social network system to store information indicative of the current employer of the member represented by the respective profile.

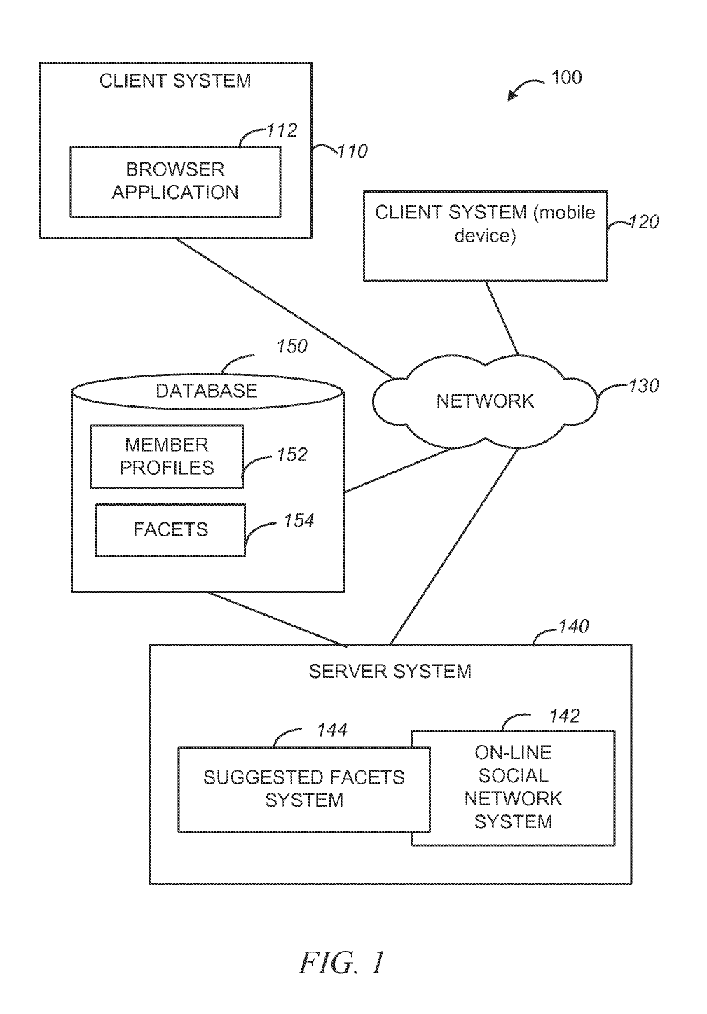

In some embodiments, the search system may be configured to populate the search box with a new input string corresponding to the selected query suggestion. As shown in FIG. 5, the search box 510 is populated with the string “People who work at LinkedIn.” The search system permits a user to edit the string in the search box and to request a further search based on the edited string in the search box. Example method and system to assist a user in formulating a search query may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

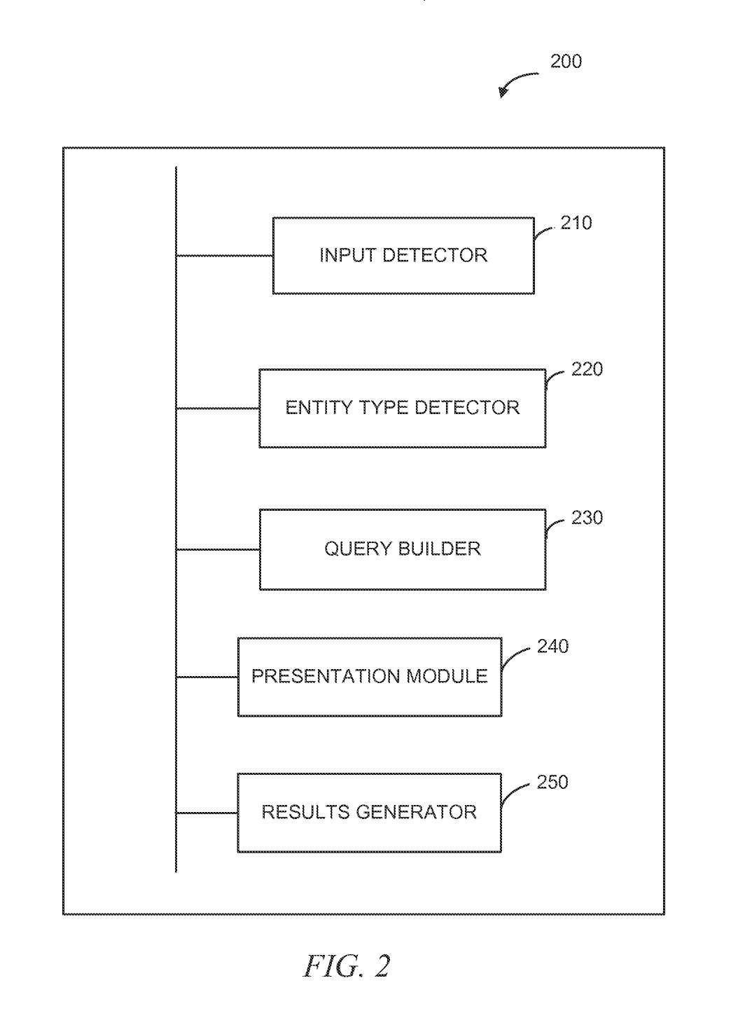

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a search system 144 that may be utilized beneficially to aid users in formulating a search request and building a structured query. The search system 144 may be configured to examine an input string submitted by a user via a search box and present suggestions in the form of structured queries. As explained above, as a user starts typing an input string into the search box, the search system 144 determines an entity and an entity type that corresponds to the input string (or an auto-completed version of the input string) and generates search suggestions in the form of complex structured queries. The search suggestions may include the determined entity, a relationship operator suitable for expressing a relationship with an entity of that entity type, and an identification of a further entity type that can be related to the determined entity in a manner expressed by the relationship operator. The search suggestions may be presented on a display device (e.g., on a display device of the client 110 or on a display device of the client 120). If a user selects one of the suggested queries, the search system 144 processes the selected query and generates search results that can be presented on the display device of the user. The search system may be configured to populate the search box with a new input string corresponding to the selected query suggestion. An example search system 144 is illustrated in FIG. 2.

FIG. 2 is a block diagram of a system 200 to assist a user in formulating a search query, in accordance with one example embodiment. As shown in FIG. 2, the system 200 includes an input detector 210, an entity type detector 220, a query builder 230, and a presentation module 240. The input detector 210 may be configured to detect an input string in a search box, which may be presented on a display device as part of a user interface of a computing application. The computing application may maintain a plurality of profiles stored in the database 150 of FIG. 1 and may be the on-line social networking system 142 of FIG. 1. The entity type detector 220 may be configured to determine an entity type for an input string. The entity type detector 220 may also be configured to autocomplete the input string and to determine that the resulting entity string corresponds to an entity of a certain entity type.

The query builder 230 may be configured to generate a structured query based on the input string. The structured query may include one or more entities of the same or different entity types, and one or more relationship operators. A relationship operator may indicate a relationship with an entity of a certain entity type. An entity type identifies a group of profiles from the plurality of profiles that are grouped based on predetermined criteria. For example, an entity type may be associated with profiles that represent respective companies. A relationship operator may indicate relationships, such as current employment of a person represented by an entity at a company represented by another entity. Another relationship operator may indicate past employment of a person represented by an entity at a company represented by another entity. The presentation module 240 may be configured to cause presentation, on a display device, a query suggestion as a link for activation of the structured query.

The input detector 210 may be further configured to detect a selection of a query suggestion. A query suggestion may represent a complex structured query that includes an entity of a certain entity type corresponding to the input string, an identification of a further entity type and a relationship operator indicating a relationship between the entity and the further entity type. A results generator 250, also shown as part of the system 200, may be configured to examine a subject field in those profiles from the plurality of profiles that represent respective entities of the further entity type, and include, in search results, those profiles from the plurality of profiles that represent respective entities of the further entity type and also include an identification of the entity in the subject field.

For example, in the query that corresponds to the string “People who work at LinkedIn,” the string “People” corresponds to an entity type “people,” the string “LinkedIn” corresponds to an entity of type “company, and that the string “who works at” corresponds to a relationship operator. The results generator 250 may process this query by examining only those profiles in the on-line social network system that represent people (and not companies, or schools, etc.) and, in the profiles that represent people, only examine the profile section (the subject field) that is designated by the on-line social network system to store information indicative of the current employer of the member represented by the respective profile. The presentation module 240 may be configured is to cause presentation of the search results on a display device of the user who initiated the search.

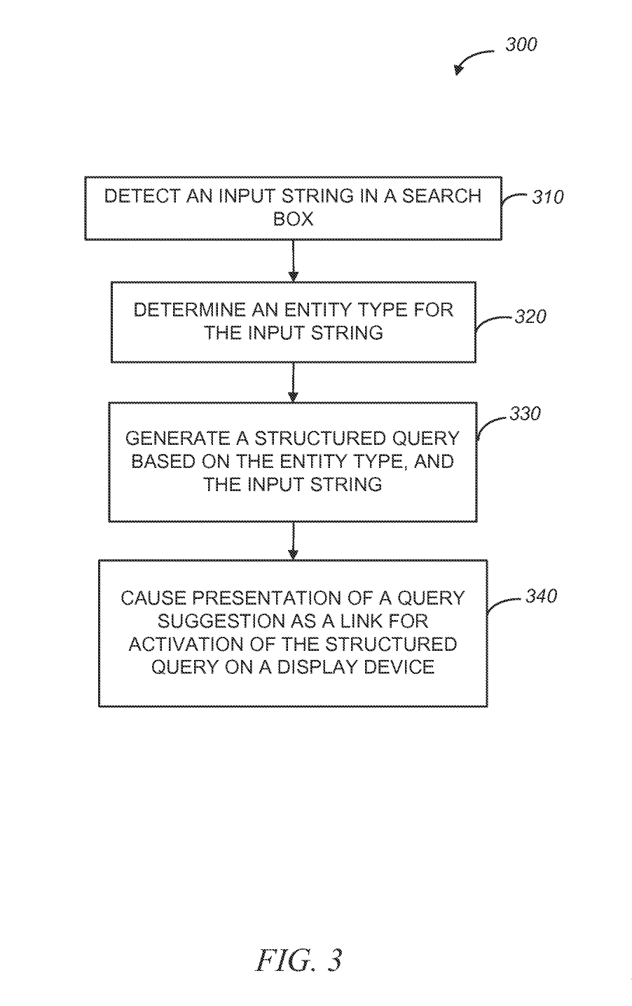

In one embodiment, the query builder 230 may be configured is to populate the search box with a, the new input string corresponding to the selected query suggestion. When the input detector 210 detects a modification of the new input string, the query builder 230 generates a new structured query and the presentation module 240 causes presentation, on a display device, a new query suggestion as a link for activation of the new structured query. Some operations performed by the system 200 may be described with reference to FIG. 3.

FIG. 3 is a flow chart of a method 300 to assist a user in formulating a search query, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the input detector 210 of FIG. 2 detects an input string in a search box, which may be presented on a display device as part of a user interface of a computing application. At operation 320, the entity type detector 220 of FIG. 2 determines an entity type corresponding to the input string. At operation 330, the query builder 230 of FIG. 2 generates a structured query, based on the input string. As explained above, a structured query may include one or more entities of the same or different entity types, and one or more relationship operators. At operation 340, the presentation module 240 causes presentation, on a display device, a query suggestion as a link for activation of the structured query.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

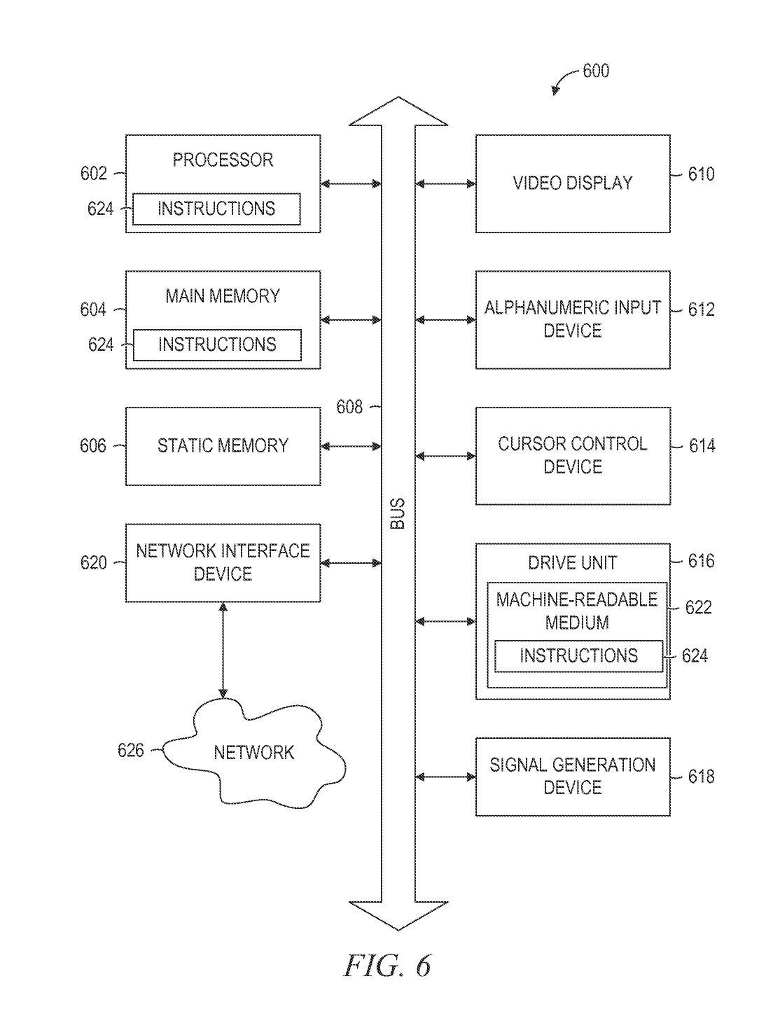

FIG. 6 is a diagrammatic representation of a machine in the example form of a computer system 600 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 606. The computer system 600 may further include a video display unit 610 (e.g., a liquid crystal display (LCD) or a cathode ray tube (CRT)). The computer system 600 also includes an alpha-numeric input device 612 (e.g., a keyboard), a user interface (UI) navigation device 614 (e.g., a cursor control device), a disk drive unit 616, a signal generation device 618 (e.g., a speaker) and a network interface device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, with the main memory 604 and the processor 602 also constituting machine-readable media.

The software 624 may further be transmitted or received over a network 626 via the network interface device 620 utilizing any one of a number of well-known transfer protocols (e.g., Hyper Text Transfer Protocol (HTTP)).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to assist a user in formulating a search query have been described. While the techniques for formulating a search query have been described with reference to searches in the context of an on-line social network system, the method and system to assist a user in formulating a search query may be used beneficially in any context where electronic search results are being requested and retrieved. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
detecting an input string in a search box, the search box presented on a display device as part of a user interface of a computing application, the computing application maintaining a plurality of profiles;
determining an entity type for the input string in response to the detecting;
generating, using at least one processor, a structured query, the structured query including an entity of the entity type, the entity corresponding to the input string, the structured query further including an identification of a further entity type and a relationship operator, the relationship operator indicating a relationship between the entity and the further entity type; and
causing presentation, on a display device, a query suggestion as a link for activation of the structured query.

2. The method of claim 1, wherein the determining of the entity type for the input string comprises autocompleting the input string to generate the entity string and determining that the entity string corresponds to the entity of the entity type.

3. The method of claim 1, wherein the entity type identifies profiles from the plurality of profiles that represent a company and the further entity type identifies profiles from the plurality of profiles that represent a company.

4. The method of claim 3, wherein the relationship operator indicates current employment of a person represented by a profile of the further entity type at a company represented by the entity.

5. The method of claim 3, wherein the relationship operator indicates past employment of a person represented by a profile of the further entity type at a company represented by the entity.

6. The method of claim 1, comprising:
detecting a selection of the query suggestion, the query suggestion representing a query comprising the entity corresponding to the input string, the identification of the further entity type and the relationship operator indicating the relationship between the entity and the further entity type; and
examining a subject field in those profiles from the plurality of profiles that represent respective entities of the further entity type, and
including, in search results, those profiles from the plurality of profiles that represent respective entities of the further entity type and also include an identification of the entity in the subject field.

7. The method of claim 6, comprising causing presentation of the search results on the display device.

8. The method of claim 6, comprising populating the search box with a new input string corresponding to the selected query suggestion.

9. The method of claim 8, comprising:
detecting a modification of the new input string;
in response to the detecting of the modification of the new input string, generating a new structured query; and
causing presentation, on the display device, a new query suggestion as a link for activation of the new structured query.

10. The method of claim 1, wherein the computing application is an on-line social network system.

11. A computer-implemented system comprising:
an input detector, implemented using at least one processor, to detect an input string in a search box, the search box presented on a display device as part of a user interface of a computing application, the computing application maintaining a plurality of profiles;
an entity type detector, implemented using at least one processor, to determine an entity type for the input string in response to the detecting,
a query builder, implemented using at least one processor, to generate a structured query, the structured query including an entity of the entity type, the entity corresponding to the input string, the structured query further including an identification of a further entity type and a relationship operator, the relationship operator indicating a relationship between the entity and the further entity type, and
a presentation module, implemented using at least one processor, to cause presentation, on a display device, a query suggestion as a link for activation of the structured query.

12. The system of claim 11, wherein the entity type detector is to autocomplete the input string to generate the entity string and to determine that the entity string corresponds to the entity of the entity type.

13. The system of claim 11, wherein the entity type identifies profiles from the plurality of profiles that represent a company and the further entity type identifies profiles from the plurality of profiles that represent a company.

14. The system of claim 13, wherein the relationship operator indicates current employment of a person represented by a profile of the further entity type at a company represented by the entity.

15. The system of claim 13, wherein the relationship operator indicates past employment of a person represented by a profile of the further entity type at a company represented by the entity.

16. The system of claim 11, wherein the input detector is to detect a selection of the query suggestion, the query suggestion representing a query comprising the entity corresponding to the input string, the identification of the further entity type and the relationship operator indicating the relationship between the entity and the further entity type,
the system including a results generator, implemented using at least one processor, to:
examine a subject field in those profiles from the plurality of profiles that represent respective entities of the further entity type, and
include, in search results, those profiles from the plurality of profiles that represent respective entities of the further entity type and also include an identification of the entity in the subject field.

17. The system of claim 16, wherein the presentation module is to cause presentation of the search results on the display device.

18. The system of claim 16, wherein the query builder is to populate the search box with a, the new input string corresponding to the selected query suggestion.

19. The system of claim 18, wherein:
the input detector is to detect a modification of the new input string;
the query builder is to generate a new structured query in response to the detecting of the modification of the new input string; and
the presentation module is to cause presentation, on the display device, a new query suggestion as a link for activation of the new structured query.

20. A machine-readable non-transitory storage medium having instruction data executable by a machine to cause the machine to perform operations comprising:
detecting an input string in a search box, the search box presented on a display device as part of a user interface of a computing application, the computing application maintaining a plurality of profiles;
determining an entity type for the input string in response to the detecting;
generating a structured query, the structured query including an entity of the entity type, the entity corresponding to the input string, the structured query further including an identification of a further entity type and a relationship operator, the relationship operator indicating a relationship between the entity and the further entity type; and
causing presentation, on a display device, a query suggestion as a link for activation of the structured query.
